(19) United States
(12) Patent Application Publication
(10) Pub. No.: US 2018/0253155 A1
(43) Pub. Date: Sep. 6, 2018

(54) PRIVATE ACCESS TO HUMAN INTERFACE DEVICES

(71) Applicant: DISPLAYLINK (UK) LIMITED, Cambridge (GB)

(72) Inventor: Douglas Morse, Houghton (GB)

(21) Appl. No.: 15/761,806

(22) PCT Filed: Sep. 21, 2016
(86) PCT No.: PCT/GB2016/052937

§ 371 Date: Mar. 20, 2018

(30) Foreign Application Priority Data
Sep. 21, 2015 (GB) 1516692.9

(51) Int. Cl. G06F 3/038; G06F 3/0489; G06F 13/10; G06F 13/40; H04W 4/30

(52) U.S. Cl. CPC G06F 3/038; G06F 3/0489; H04W 4/30; G06F 13/4068; G06F 13/102

(57) ABSTRACT

A method of communication between a human interface device, HID, and a mobile device (11) involves operating, on the mobile device (11), an operating system (21) providing an execution space for applications and operating a user application (22) in the execution space, where the user application (22) operates independently of the operating system (21). The user application (22) controls a communication interface (23) of the mobile device (11) via a private interface (27) that is not accessible to the operating system (21). Image data for display on an external display device (13), connected to the communication interface (23), is packaged as general-purpose data. Other HIDs (14, 15) can be connected to the communication interface (23), and controlled by the user application (22). In this way the operating system (21) does not require any drivers for the HIDs (14, 15) that are connected to the mobile device (11) via the communication interface (23).

### CROSS-REFERENCE TO RELATED APPLICATIONS

This application is a U.S. national stage continuation application under 35 U.S.C. § 371 of International Patent Application No. PCT/GB2016/052937, filed on Sep. 21, 2016, which claims the benefit of Great Britain Patent Application No. 1516692.9, filed on Sep. 21, 2015, the contents of each of which are incorporated herein by reference in their entirety.

### BACKGROUND

As mobile devices such as smartphones, tablet computers and even wearable devices such as smart watches become more powerful, it is becoming increasingly common for users to wish to use such devices in place of conventional computing devices such as PCs, especially in a hotdesking environment. However, most mobile devices only have small integral displays and are not provided with keyboards, mice or other human interface (input) devices (“HIDs”) associated with desktop computers. It is therefore desirable to connect such devices to a mobile device that is being used as a computer in order to increase ease of use.

In order to connect a human interface device to a mobile device, the mobile device needs to provide various drivers to be able to connect to the various interface devices. Conventionally, such drivers, when present, must be incorporated into the code of the mobile device's operating system. This requires co-operation between multiple manufacturers and possibly designers of operating systems and is difficult due to the wide variety of human interface devices for which drivers would need to be provided. Alternatively, if it is required to add a driver later, it usually requires an upgrade of the full operating system into which the driver is incorporated. This means that it is difficult to add suitable drivers to mobile devices to allow HIDs to be connected.

The invention attempts to solve or at least mitigate this problem.

### BRIEF SUMMARY

According to a first aspect of the invention, there is provided a method of communication between a human interface device, HID, and a mobile device, the method comprising:
operating, on a mobile device, an operating system providing an execution space for applications;
operating, on the mobile device, a user application in the execution space, wherein the user application operates independently of the operating system and comprises a display component for generating display data, a processing component for processing the display data to produce image data for display and an output component for transmitting the image data to a communication interface of the mobile device;
detecting, by the user application, a connection of an external display device to the mobile device via the communication interface of the mobile device;
controlling, by the user application, the communication interface of the mobile device via a private interface that is not accessible to the operating system;
sending, by the user application via the communication interface, the image data for display on the external display device, wherein the communication interface packages the image data as general-purpose data;
detecting, by the user application, a connection of one or more HIDs to the mobile device via the communication interface;
communicating, by the user application, with the one or more HIDs using the communication interface; and
showing, by the processing component of the user application, any visible results of interaction with the one or more HIDs in the image data to be sent to the external display device,

whereby the operating system does not require any drivers for the one or more HIDs that are connected to the mobile device via the communication interface.

Thus, by installing an application on the mobile device, no drivers for the HID need be specifically incorporated into the operating system. This is beneficial because it allows the user application to control other devices alongside the external display device without having to set up a second connection. Furthermore, the communication interface with the connected HID—for example, a mouse—will be entirely within the user application and the operating system will not be aware of the nature or origins of the input data from the mouse and will not interact with it, removing the need for drivers, which are effectively provided within the user application itself.

In one embodiment, the method further comprises:
granting, by the operating system, memory space to the user application when the user application is executed in the execution space; and
creating, by the user application, a frame buffer within the memory space and storing the image data to be sent to the external display device therein.

As such, the user application is able to send image data to the display device without any interaction with the operating system of the mobile device. This minimises interaction with the operating system and therefore necessary changes to the operating system. However, the user application may pass completed image data to the operating system to be output to the display device. Each of a number of applications within a family of applications seeking to take advantage of various embodiments of the invention could have its own interface with the connected HIDs. This is not problematic as most mobile devices only run one application at a time in any case and it may therefore be beneficial as it ensures clarity as to which application has control of the HID at any time.

According to a second aspect of the invention, there is provided a mobile device arranged to carry out the first aspect of the invention.

Advantageously, there may be provided only one connection port for external devices, which can be connected to a hub which in turn may be connected to multiple external devices. This is advantageous because it is desirable to have as few connection ports in a mobile device as possible in order to minimise size and maximise the strength of the device's case. The hub may be embodied as part of a desktop docking station.

The connection port or ports may be embodied as a capability for a wireless data connection and, accordingly, all connections may be either wired or wireless.

### BRIEF DESCRIPTION OF THE DRAWINGS

An embodiment of the invention will now be more fully described, by way of example, with reference to the drawings, of which:

FIG. 1 shows a basic schematic of an embodiment of the whole system;

FIG. 2 shows a more detailed schematic of the mobile device and hub shown in FIG. 1, together with software components, especially those responsible for the production of image data;

FIG. 3 shows a similar schematic of the mobile device and hub to FIG. 2, together with software components responsible for receiving user input; and

FIG. 4 shows a flow chart of the process followed by the application.

### DETAILED DESCRIPTION

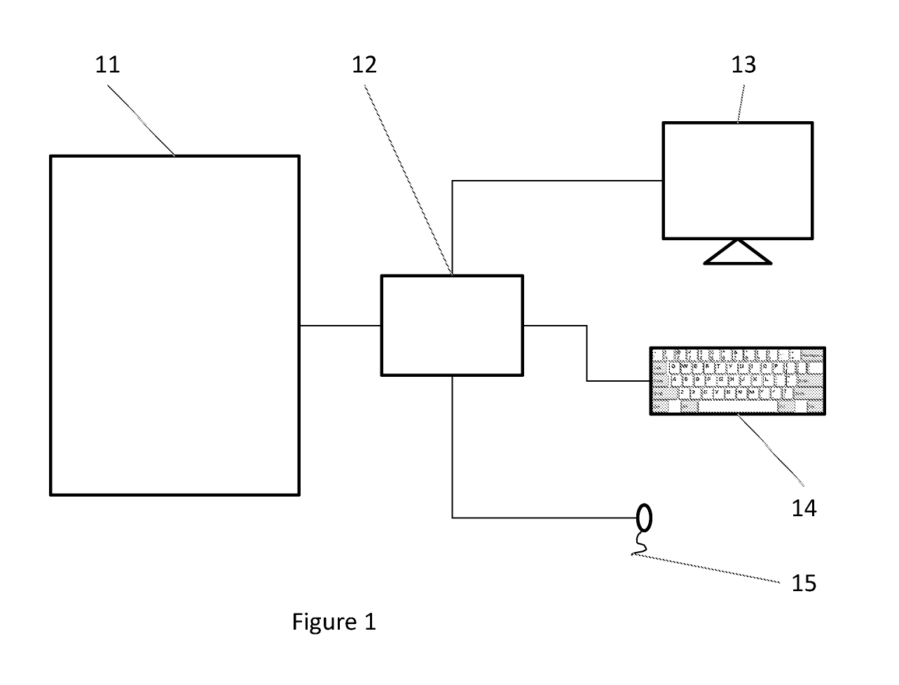

FIG. 1 shows a mobile device [11] connected to a docking station [12]. The connection may be wired or wireless and may be over a network, including the internet, as long as it is capable of carrying general-purpose data. For the purpose of the embodiment shown in these diagrams, the connection is wireless via Wi-Fi.

The docking station [12] is in turn connected to a display device [13], keyboard [14], and mouse [15]. In this example, the connections between the docking station [12] and the human interface devices [14, 15] are all one-way: the keyboard [14] and mouse [15] provide input data only. The connection with the display device [13] could be one-way, or, where the display device [13] incorporates a touchscreen, the connection to the display device [13] could be two-way. However, since the data would be travelling along different lanes within the same connection, these lanes could be treated as two one-way connections and the principle is the same.

The intention is for the mobile device [11] to be able to supply display data to the display device [13] while receiving user input from the mouse [14] and keyboard [15] and also incorporating this into the display data transmitted to the display device [13]. Although it is known to transmit display data from a mobile device [11] to a display device [13], it is not known to receive external input through the same communication interface connection.

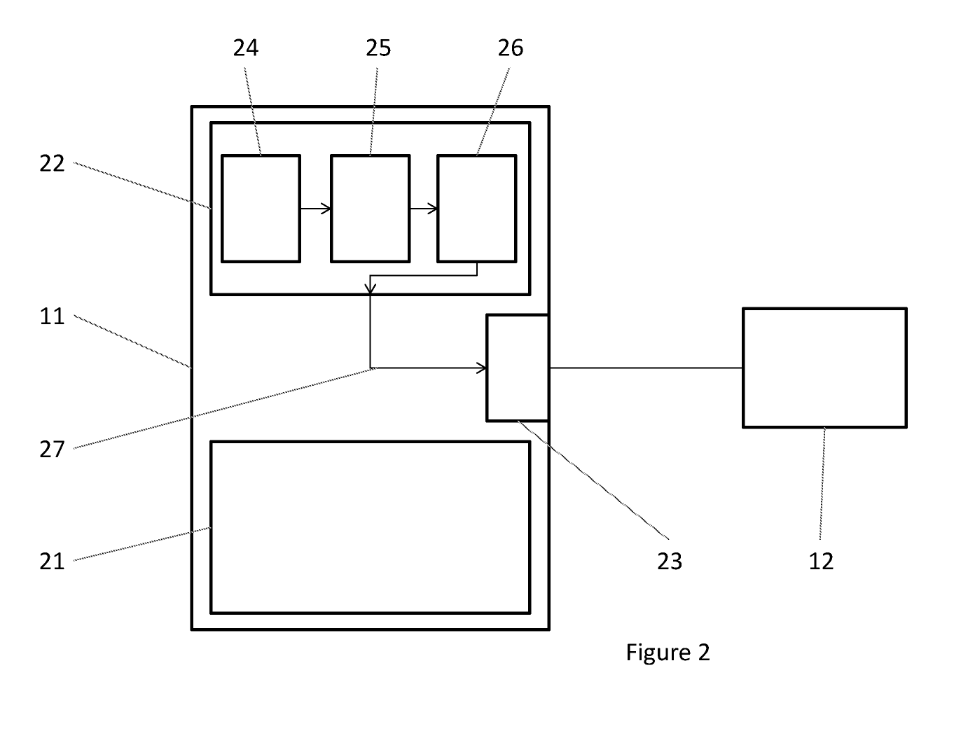

FIG. 2 shows a detail of the same mobile device [11], connected to the same docking station [12]. The human interface devices [14, 15] and the display device [13] are still present as shown in FIG. 1, but they are not shown here for clarity.

Two software components [21, 22] are shown running on the mobile device. In practice these are likely to be running simultaneously on the same processor and using the same main memory space, but they are shown separately for clarity. The first software component [21] is the main operating system of the mobile device [11]. Conventionally, this would need to be amended either at manufacture and original installation or by the installation of a driver in order to allow the user to connect any particular HID, and to connect to a display device. However, according to particular embodiments of the invention, the operating system [21] is not involved in interaction with the HIDs or the display device as this is handled within an application. This is shown as the second software component [22] in FIG. 2.

FIG. 2 shows only the elements of the application [22] used in the production and transmission of display data. These elements [24, 25, 26] are shown as three parts within the application [22], although in practice they will be running together and using the same memory allocated by the operating system [21] for the use of the application [22], in the same way as the application [22] and operating system [21] are not in fact stored and run separately but are here shown separately as described above. There may be other components in the application [22], depending on its functionality, but these are not here shown.

The first [24] of the three elements is a software component that generates display data (a “display component”). It then passes this data to the second component [25], which processes the data to make it suitable for display (the “processing component”). This may include blending different types of display data or display data from different sources, colour correction and processing, scaling according to the resolution of the display device [13], and other functions. The aim of this component is to produce a frame, which may be stored in a frame buffer in memory space allocated to the application [22], or may be passed directly to the third element [26] (the “output component”): a component that transmits the finished data to the communication interface [23] of the mobile device [11].

The application [21] is able to communicate with the communication interface [23] through a private interface [27]. On most mobile devices only one application will be active at a time, so the active application [21] may be able to entirely monopolise the communication interface [23] so that not even the operating system [21] is able to communicate with it. In other cases, the application [22] may only monopolise some part of the communication interface's [23] functionality. In any case, the private interface [27] may be inaccessible to the operating system [21] or any other application.

In this embodiment, the output component [26] streams display data directly to the communication interface [23], although in other embodiments there may be an intervening area of memory that acts as a flow buffer. The communication interface [23] then converts the flow of display data to Wi-Fi packets and transmits them to the docking station [12], which is able to perform any further processing and transmit them on to the display device [13].

The communication interface [23] is capable of both transmitting and receiving data and, as previously mentioned, the application [22] has a private interface [27] with it. This means that the communication interface [23] can be used for data transmission in both directions.

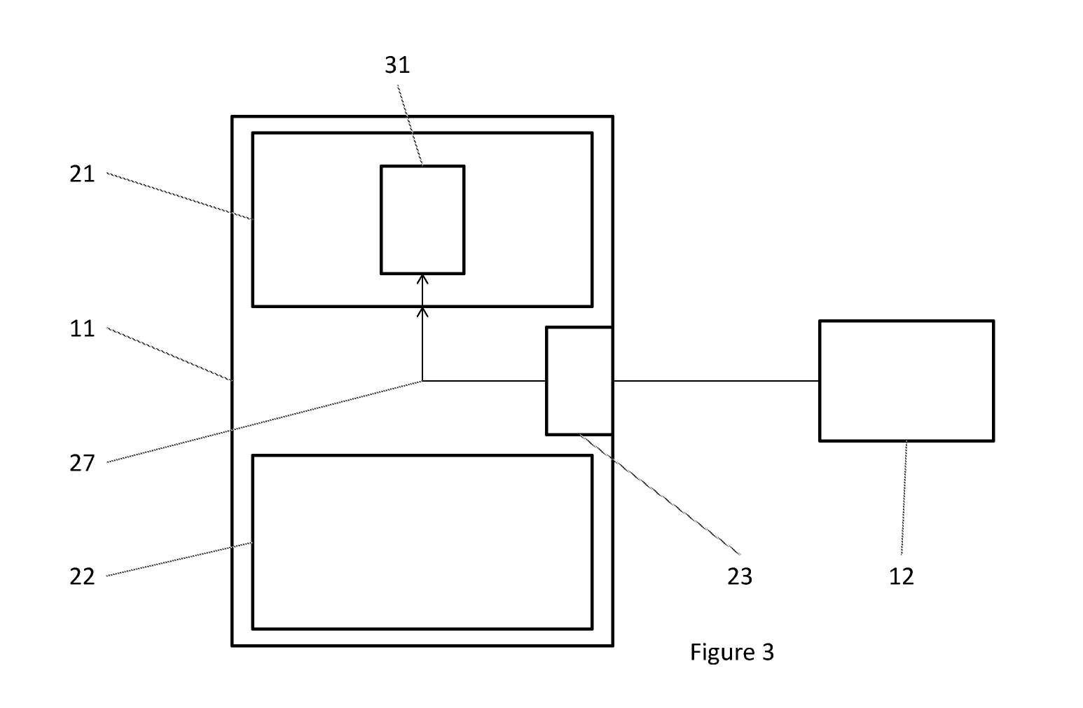

FIG. 3 once again shows the same mobile device [11] and docking station [12], the mobile device [11] including the same operating system [21], application [22], and communication interface [23]. In FIG. 3, only one component [31] of the application [22] is shown: the input component [31]. This is in communication with the communication interface [23] via the private interface [17], but, as is shown by the arrows, the communication interface [23] receives data from the two input devices [14, 15] and sends it to the input component [31].

The input component [31] is in communication with both the application's [22] local memory and the processing component [25]. This means that data received through the private interface [27] can be placed in memory if appropriate—for example, words being typed into a document—and the changes to the display data such as movement of a cursor can be immediately reflected in the display data output by the application [22]. For this reason, these methods and adaptations to the mobile device [11] are most suitable for input data that causes a visible change in the display output.

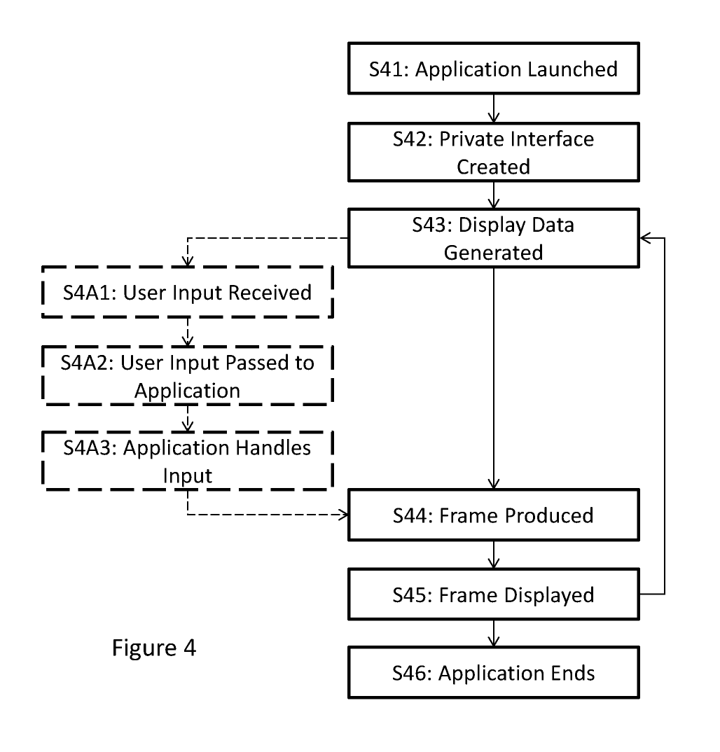

FIG. 4 shows the overall process starting from the launch of the application [22]. The application [22] will have been previously installed and will be aware of the existence of the communication interface [23] and how to communicate with it—this is information that could be requested from the communication interface [23] itself or read from the operating system [21] upon installation.

At Step S41, the application [22] is launched. This may be by user choice or as the result of an automatic process. It then creates the private interface [27] with the communication interface [23] at Step S42. As part of this, or separately, it will query the capabilities of any connected display device or, as in this case, docking station [12], in which case it will send querying messages on through the docking station [12] to the display device [13]. It will use the results of these queries, such as resolution, number of display devices, refresh rate, etc., to inform the behaviour of the components [24, 25, 26] within the application [22], especially the processing component [25] and the output component [26].

It will also query for any other peripherals [14, 15] connected either to a docking station [12] or, in some cases, directly to the communication interface [23]. If there are such peripherals [14, 15], as here, it will configure itself to receive input from them through the private interface [27], which otherwise would only be configured to transmit data. In all cases, the communication interface [23] is unaware of the nature of the data being transmitted; it is just packaging it as a general-purpose format and transmitting it across a general-purpose connection: in this case, Wi-Fi.

At Step S43, the display component [24] begins generating display data.

At this stage, the user may use the keyboard [14] or mouse [15] to input data. This is unlikely to occur on every frame, so this is not handled as part of the main process, although the application [22] will be constantly listening for such input. It will also listen for the connection of a new HID and, upon receiving a signal indicating that a device has been connected to the docking station [12], it will query that device as described at Step S42. If there was originally only a display device [13], the application [22] will then return to Step S42 and re-configure the private interface [27] to be able to receive data as well as transmitting it.

If, at Step S43, the user inputs data, the process will follow the branch labelled ‘A’ and indicated as optional by the dotted boxes and arrows. Otherwise, the process will move directly to Step S44.

At Step S4A1, the user has input data by, for example, typing on the keyboard [14]. This data is transmitted from the keyboard [14] to the interface engine [23] of the mobile device [11], via the docking station [12] to which they are both connected as aforementioned. The interface engine [23] is not aware of the nature of the data but just removes the Wi-Fi packaging and directs it to the application [22] to which it is addressed, along the private interface [27], at Step S4A2.

When the application [22] receives the user input, it is aware of the source and type of the input—this may be contained in internal packet headings, for example. There may also be specific packets containing an indication of an expected reaction. For example, a mouse movement and click may be transmitted in a signal that contains the new location and the fact that the mouse was clicked at that location. The application [22] then reacts to that input at Step S4A3. This may mean, for example, placing a piece of data in memory, or altering the display data generated by the display component [24].

In either case, the processing component [25] of the application [22] produces a complete frame of display data at Step S44. If there is no user input, the processing component [25] will produce a frame entirely comprising the output from the display component [24]. If there is user input, the processing component [25] will amend the output from the display component [24] appropriately, for example by adding a letter at the appropriate location in response to a key-press on the keyboard [14]. When the frame is complete, the processing component [24] stores it in a frame buffer in the memory space and passes it to the output component [26], which will in turn pass it to the communication interface [23].

At Step S45, the frame is then transmitted to the communication interface [23] as previously described. The communication interface [23] is not aware that it is display data, but will package it as general-purpose Wi-Fi data and may also compress and encrypt it. It then transmits it to the docking station [12], where it may be decompressed and decrypted if appropriate and may also undergo further processing; for example, it may require resealing prior to transmission to the display device [13]. When this is complete, it is transmitted to the display device [13] in the appropriate format and displayed.

As long as the application [22] is running, the steps between Step S43 and S45 inclusive, including Steps S4A1 to S4A3 as appropriate, will repeat. They may be pipelined such that the processing component [25] is producing a frame simultaneously with the interface engine [23] transmitting the previous frame, for example, and if one or more frame buffers are provided in memory then one or more frames may be stored prior to transmission, resulting in the communication interface [23] transmitting a frame multiple frames ahead of the frame currently being produced by the processing component [25].

At Step S46, the application [22] ends. This may be automatically or due to user input, and will result in the removal of resources dedicated to the application [22]. This includes the return of memory to a central pool under the control of the operating system [21], but will also include the removal of the private interface [27]. This means that the application [22] will no longer be monopolising the use of the communication interface [23] and this can be used by the operating system [21] or another application. It also means that the display device [13], mouse [15], and keyboard [14] will cease to function until the application is launched again.

An application can use this process to use appropriate peripherals without any modification to the operating system running on the mobile device. This makes deployment of such functionality more straightforward.

Embodiments are also described in the following numbered clauses.

1. A method of communication between a human interface device, HID, and a mobile device, the method comprising:
operating, on a mobile device, an operating system providing an execution space for applications;
operating, on the mobile device, a user application in the execution space;
detecting, by the user application, a connection of an external display device to the mobile device via a communication interface of the mobile device;
controlling, by the user application, the communication interface of the mobile device;
sending, by the user application, image data for display on the external display device;
detecting, by the user application, a connection of one or more HIDs to the mobile device via the communication interface;
communicating, by the user application, with the one or more HIDs using the communication interface; and
showing, by the user application, any visible results of interaction with the one or more HIDs in the image data to be sent to the external display device.

2. A method according to clause 1, wherein the communication interface comprises one or more ports on the mobile device for connection directly to the external device and the one or more HIDs.

3. A method according to clause 1, wherein the communication interface comprises a port on the mobile device for connection to the external device and the one or more HIDs via a hub.

4. A method according to clause 3, wherein the hub comprises a docking station.

5. A method according to clause 1, wherein the communication interface comprises a wireless interface for wireless communication with the external display device and the one or more HIDs.

6. A method according to any preceding clause, further comprising:
granting, by the operating system, memory space to the user application when the user application is executed in the execution space; and
creating, by the user application, a frame buffer within the memory space and storing the image data to be sent to the external display device therein.

7. A method according to any preceding clause, further comprising:
closing operation of the user application in the execution space;
operating, on the mobile device, a second user application in the execution space;
detecting, by the second user application, a connection of the external display device to the mobile device via the communication interface of the mobile device;
controlling, by the second user application, the communication interface of the mobile device;
sending, by the second user application, the image data for display on the external display device;
detecting, by the second user application, a connection of a second HID to the mobile device via the communication interface;
communicating, by the second user application, with the second HID using the communication interface; and
showing, by the second user application, any visible results of interaction with the second HID in the image data to be sent to the external display device.

8. A method according to any preceding clause, further comprising:
granting, by the operating system, second memory space to the second user application when the second user application is executed in the execution space; and
creating, by the second user application, a second frame buffer within the memory space and storing the image data to be sent to the external display device therein.

9. A method according to any preceding clause, wherein the image data is sent by the user application to the external display device via the communication interface.

10. A method according to any preceding clause, wherein the one or more HIDs comprises one or more of a mouse and a keyboard.

11. A mobile device configured to perform all the steps of a method according to any one of the preceding clauses.

12. A computer readable medium including executable instructions which, when executed in a processing system, cause the processing system to perform all the steps of a method according to any one of clauses 1 to 10.

1. A method of communication between a human interface device, HID, and a mobile device, the method comprising:
operating, on a mobile device, an operating system providing an execution space for applications;
operating, on the mobile device, a user application in the execution space, wherein the user application operates independently of the operating system and comprises a display component for generating display data, a processing component for processing the display data to produce image data for display and an output component for transmitting the image data to a communication interface of the mobile device;
detecting, by the user application, a connection of an external display device to the mobile device via the communication interface of the mobile device;
controlling, by the user application, the communication interface of the mobile device via a private interface that is not accessible to the operating system;
sending, by the user application via the communication interface, the image data for display on the external display device, wherein the communication interface packages the image data as general-purpose data;
detecting, by the user application, a connection of one or more HIDs to the mobile device via the communication interface;
communicating, by the user application, with the one or more HIDs using the communication interface; and
showing, by the processing component of the user application, any visible results of interaction with the one or more HIDs in the image data to be sent to the external display device,
whereby the operating system does not require any drivers for the one or more HIDs that are connected to the mobile device via the communication interface.

2. The method according to claim 1, wherein the communication interface comprises one or more ports on the mobile device for connection directly to the external device and the one or more HIDs.

3. The method according to claim 1, wherein the communication interface comprises a port on the mobile device for connection to the external device and the one or more HIDs via a hub.

4. The method according to claim 3, wherein the hub comprises a docking station.

5. The method according to claim 1, wherein the communication interface comprises a wireless interface for wireless communication with the external display device and the one or more HIDs.

6. The method according to claim 1, further comprising:
granting, by the operating system, memory space to the user application when the user application is executed in the execution space; and
creating, by the user application, a frame buffer within the memory space and storing the image data to be sent to the external display device therein.

7. The method according to claim 1, further comprising:
closing operation of the user application in the execution space;
operating, on the mobile device, a second user application in the execution space;
detecting, by the second user application, a connection of the external display device to the mobile device via the communication interface of the mobile device;
controlling, by the second user application, the communication interface of the mobile device;
sending, by the second user application, the image data for display on the external display device;
detecting, by the second user application, a connection of a second HID to the mobile device via the communication interface;
communicating, by the second user application, with the second HID using the communication interface; and
showing, by the second user application, any visible results of interaction with the second HID in the image data to be sent to the external display device.

8. The method according to claim 1, further comprising:
granting, by the operating system, second memory space to the second user application when the second user application is executed in the execution space; and
creating, by the second user application, a second frame buffer within the memory space and storing the image data to be sent to the external display device therein.

9. The method according to claim 1, wherein the one or more HIDs comprises one or more of a mouse or a keyboard.

10. A mobile device configured to:
operate, on the mobile device, an operating system providing an execution space for applications;
operate, on the mobile device, a user application in the execution space, wherein the user application operates independently of the operating system and comprises a display component for generating display data, a processing component for processing the display data to produce image data for display and an output component for transmitting the image data to a communication interface of the mobile device;
detect, by the user application, a connection of an external display device to the mobile device via the communication interface of the mobile device;
control, by the user application, the communication interface of the mobile device via a private interface that is not accessible to the operating system;
send, by the user application via the communication interface, the image data for display on the external display device, wherein the communication interface packages the image data as general-purpose data;
detect, by the user application, a connection of one or more HIDs to the mobile device via the communication interface;
communicate, by the user application, with the one or more HIDs using the communication interface; and
show, by the processing component of the user application, a visible result of an interaction with the one or more HIDs in the image data to be sent to the external display device,
wherein the operating system does not require any drivers for the one or more HIDs that are connected to the mobile device via the communication interface.

11. A computer readable medium including executable instructions which, when executed in a processing system, cause the processing system to perform operations comprising:
operating, on a mobile device, an operating system providing an execution space for applications;
operating, on the mobile device, a user application in the execution space, wherein the user application operates independently of the operating system and comprises a display component for generating display data, a processing component for processing the display data to produce image data for display and an output component for transmitting the image data to a communication interface of the mobile device;
detecting, by the user application, a connection of an external display device to the mobile device via the communication interface of the mobile device;
controlling, by the user application, the communication interface of the mobile device via a private interface that is not accessible to the operating system;
sending, by the user application via the communication interface, the image data for display on the external display device, wherein the communication interface packages the image data as general-purpose data;
detecting, by the user application, a connection of one or more HIDs to the mobile device via the communication interface;
communicating, by the user application, with the one or more HIDs using the communication interface; and
showing, by the processing component of the user application, a visible result of an interaction with the one or more HIDs in the image data to be sent to the external display device,
whereby the operating system does not require any drivers for the one or more HIDs that are connected to the mobile device via the communication interface.

12. The mobile device according to claim 10, wherein the communication interface comprises one or more ports on the mobile device for connection, either directly or via a hub, to the external device and the one or more HIDs.

13. The mobile device according to claim 10, wherein the communication interface comprises a wireless interface for wireless communication with the external display device and the one or more HIDs.

14. The mobile device according to claim 10, further configured to:
grant, by the operating system, memory space to the user application when the user application is executed in the execution space;
create, by the user application, a frame buffer within the memory space; and
store the image data to be sent to the external display device therein.

15. The mobile device according to claim 10, further configured to:
close operation of the user application in the execution space;
operate, on the mobile device, a second user application in the execution space;
detect, by the second user application, a connection of the external display device to the mobile device via the communication interface of the mobile device;
control, by the second user application, the communication interface of the mobile device;
send, by the second user application, the image data for display on the external display device;
detect, by the second user application, a connection of a second HID to the mobile device via the communication interface;
communicate, by the second user application, with the second HID using the communication interface; and
show, by the second user application, a visible result of an interaction with the second HID in the image data to be sent to the external display device.

16. The mobile device according to claim 10, further configured to:
grant, by the operating system, second memory space to the second user application when the second user application is executed in the execution space;
create, by the second user application, a second frame buffer within the memory space; and
store the image data to be sent to the external display device therein.

17. The mobile device according to claim 10, wherein the one or more HIDs comprises one or more of a mouse and a keyboard.

18. The computer readable medium according to claim 11, wherein the operations further comprise:
granting, by the operating system, memory space to the user application when the user application is executed in the execution space;
creating, by the user application, a frame buffer within the memory space; and
storing the image data to be sent to the external display device therein.

19. The computer readable medium according to claim 11, wherein the operations further comprise:
closing operation of the user application in the execution space;
operating, on the mobile device, a second user application in the execution space;
detecting, by the second user application, a connection of the external display device to the mobile device via the communication interface of the mobile device;
controlling, by the second user application, the communication interface of the mobile device;
sending, by the second user application, the image data for display on the external display device;
detecting, by the second user application, a connection of a second HID to the mobile device via the communication interface;
communicating, by the second user application, with the second HID using the communication interface; and
showing, by the second user application, a visible result of an interaction with the second HID in the image data to be sent to the external display device.

20. The computer readable medium according to claim 11, wherein the operations further comprise:
granting, by the operating system, second memory space to the second user application when the second user application is executed in the execution space;
creating, by the second user application, a second frame buffer within the memory space; and
storing the image data to be sent to the external display device therein.
